(19) United States
(12) Patent Application Publication
(10) Pub. No.: US 2025/0116622 A1
(43) Pub. Date: Apr. 10, 2025

(54) Detector, Control Unit and Computer Program Product and Method for Determining a Composition of a Substance Sample

(71) Applicant: Siemens Aktiengesellschaft, Muenchen (DE)

(72) Inventors: Franz STEINBACHER, Karlsruhe (DE); Konstantin HARR, Karlsruhe (DE); Josef RICHTER, Karlsruhe (DE)

(21) Appl. No.: 18/707,659

(22) PCT Filed: Sep. 2, 2022
(86) PCT No.: PCT/EP2022/074445

§ 371 Date: May 6, 2024

(30) Foreign Application Priority Data
Nov. 9, 2021 (EP) 21207197

(51) Int. Cl. G01N 27/04

(52) U.S. Cl. CPC G01N 27/045

(57) ABSTRACT

A detector, a computer program product, control unit and method for detecting a composition of a material sample, which has at least one first and second component, wherein the detector is provided in an active operating state and introduced and the material sample is introduced into a measuring cell, an electromagnetic field is generated with an adjustable field strength in the measuring cell and a conductivity between a first and a second pole of the measuring cell is detected, a first increase in conductivity between the first and second pole is detected as well as a field strength at the first increase, and the first component is identified and/or a concentration of the first component of the material sample is detected based on the first increase in conductivity previously detected and the accompanying field strength.

### CROSS-REFERENCE TO RELATED APPLICATIONS

This is a U.S. national stage of application No. PCT/EP2022/074445 filed 2 Sep. 2022. Priority is claimed on European Application No. 21207197.1 filed 9 Nov. 2021, the content of which is incorporated herein by reference in its entirety.

### BACKGROUND OF THE INVENTION

### 1. Field of the Invention

The invention relates to a method for determining a composition of a substance sample and to a detector suitable therefor, a control unit and a computer program product, each of which is suitable for carrying out the method according to the invention.

### 2. Description of the Related Art

Published patent application FR 2 683 422 A1 discloses a plasma burner in which a plasma flame is produced from a gas jet. The plasma burner has a high-frequency generator which is configured to ignite the plasma flame. The high-frequency generator generates a high-frequency magnetic field which ignites the plasma flame.

U.S. Pat. No. 4,482,246 discloses a plasma burner that is suitable for analyzing aerosols or powder samples. Emission spectroscopy of the plasma flame is performed for the purpose of analysis.

DE 10 2013 001 035 A1 discloses a sensor for evidencing a chemical species, which comprises a layer made from a semiconductor material that forms a conductive channel. The sensor likewise comprises a layer made from a gate material and an electrode pair, where each electrode is arranged at the end of the channel.

The article “Ionization Methods for the Analysis of Gases and Vapor” by J. E. Lovelock, published in Analytical Chemistry, Volume 33, No. 2, discloses an ionization detector. The ionization detector comprises two electrodes that are arranged opposite in an ionization chamber. One of the electrodes is connected to a current measurement apparatus.

There is a need in process analysis for detectors that offer elevated accuracy in determining a composition of a substance sample. At the same, time high measurement speed is required. There is likewise a requirement for such detectors to be cost-effective, robust, compact and reliable.

### SUMMARY OF THE INVENTION

In view of the foregoing, it is therefore an object of the invention is to provide method that make it possible to permit the determination of a composition of a substance sample and that offers an improvement in at least one of its presented aspects.

This and other objects and advantages are achieved in accordance with the invention by a method that detects a composition of a substance sample, where the substance sample comprises at least one first and one second component. The substance sample may furthermore be a gas mixture, a liquid mixture, an aerosol or a suspension, each of which is electrically non-conductive. The method is performed using a detector to which the substance sample is to be supplied. In a first step of the method, the detector is provided in an active operating state in which it is functional and set up for receiving the substance sample. Likewise in the first step, the substance sample is supplied to, i.e., introduced into, a measurement cell of the detector. A second step follows in which an electromagnetic field with an adjustable field strength is generated in the measurement cell. In the measurement cell, the substance sample occupies a space between a first and a second pole of the measurement cell, between which the adjustable electromagnetic field is applied. Given a sufficient field strength, the first component can be ionized by way of the adjustable electromagnetic field. The electromagnetic field is adjustable in terms of field strength by a control unit and/or a user. In particular, the field strength can be raised during the second step. In the second step, a conductivity that is present between the first and second poles and is influenced by the conductivity of the substance sample is likewise detected.

The method also comprises a third step in which a first rise in conductivity between the first and second poles is detected. The field strength at which the first rise occurs is likewise detected. Given a sufficient field strength, the first component of the substance sample is ionized, whereby its conductivity changes. Ionization of the first component proceeds substantially stepwise, i.e., without a ramp-up phase. Ionization of the first component accordingly overall brings about a substantially stepwise increase in the conductivity of the substance sample. The detector is provided with suitable further detector for detecting the conductivity between the first and second poles. The method furthermore comprises a fourth step in which the first component is identified and/or a concentration of the first component of the substance sample is determined. This occurs based on the first rise in conductivity detected in the third step and the field strength prevailing at that time. Each substance, in particular each molecule, has a characteristic ionization energy at which the associated conductivity of the substance is raised. There is thus an evaluable relationship between the electrical field strength and the energy supplied for ionization.

The invention is based inter alia on the surprising recognition that, between the ionization characteristics of substances and electrical quantities which can be detected on an appropriate detector, relationships prevail that permit the identification and quantification of components of a substance sample. Electromagnetic fields can be generated highly dynamically. Associated electrical quantities are likewise rapidly and accurately measurable. Using the method in accordance with the invention, the composition of the substance sample may consequently be reliably and accurately detected at high speed.

In accordance with the invention, the first pole is further surrounded at least in part by the second pole. Viewed cross-sectionally, the second pole accordingly surrounds the first pole at least in part. A spatially enlarged adjustable electromagnetic field is accordingly present between the first and second poles. This ensures extensive ionization of the substance sample and thus accurate detection of the substance sample's composition.

In one embodiment of the inventive method, the second pole has a cross-section that is substantially closed, for example, a circular, oval, elliptical or polygonal cross-section. As a result of such a closed cross-section, the electromagnetic field between the first and second poles is substantially free of edge effects and consequently has accurately predictable characteristics. Alternatively, the second pole may have a substantially U-shaped, C-shaped or omega-shaped cross-section. Edge effects can be minimized with such cross-sections, so simultaneously ensuring straightforward installation.

In a further embodiment of the inventive method, the concentration of the first component is determined based on a magnitude of the first rise that is detected in the third step. The higher the concentration of the first component, the greater the magnitude of the detected rise in conductivity. Alternatively or additionally, the field strength at which the rise in conductivity in the substance sample occurs due to ionization of the first component can be detected in the third step. The field strength at which a substantially stepwise first rise in conductivity occurs is characteristic of what the first component is. With the assistance of a database, a plurality of substances can thus be quickly identified as the first component. Alternatively or additionally, identification can also be made via a conductivity gradient prevailing in the third step. The gradient is determinable in the third and/or fourth step. Here, the gradient may furthermore be related to a time or another quantity which can be detected in the inventive method. Another such quantity may, for example, be the prevailing field strength or a prevailing applied DC voltage. Identification of the first component and determination of its concentration may in each case or in combined manner be performed with the assistance of artificial intelligence. Alternatively or additionally, the first component can also be identified based on a change in the corresponding gradient.

The inventive method may furthermore also be used to detect at least one second component of the substance sample. To this end, the method has a fifth step in which the electromagnetic field is further generated in the measurement cell and the conductivity between the first and second poles of the measurement cell is further detected. Here, the fifth step substantially corresponds to a continuation of the second step. Here, the electromagnetic field is generated with an adjustable field strength. The field strength is adjustable by a user and/or a control unit. In particular, the field strength can be raised during the fifth step. The method also comprises a sixth step in which a second rise in conductivity between the first and second poles is detected. The field strength at which the second rise occurs is likewise detected in the fifth step. The detector can to this end be coupled with a suitable further detector.

The method furthermore has a seventh step in which the second component of the substance sample is identified. Alternatively or additionally, the concentration of the second component of the substance sample is determined in the seventh step. The identification or determination occurs based on the second rise in conductivity between the first and second poles detected in the sixth step, and the field strength at which the second rise occurs. Here, the seventh step occurs substantially similarly to the fourth step. The seventh step is likewise based on the magnitude of the second rise mapping a concentration of the second component in the substance sample. The field strength at which the second rise occurs is, similarly to the first component, characteristic of the substance that constitutes the second component. The fifth, sixth and seventh steps can be performed repeatedly while further generating and adjusting the electromagnetic field so as in this way to identify a third, fourth, and on component of the substance sample and/or establish its concentration.

The electromagnetic field may furthermore be generated via a high-frequency generator. Here, the high-frequency generator has an excitation frequency of at least 1 MHz, preferably of at least 1 GHz and particularly preferably of 2.0 to 4.0 GHz. The high-frequency generator can further be actuatable via a user input and/or the control unit of the detector. The high-frequency generator may, for example, be adjustable via amplitude modulation, such that a high-frequency AM output signal is generated. As a result, the electromagnetic field that is to be generated in the measurement cell can be adjusted in an easy manner such that the field strength, at which the first rise in conductivity occurs between the first and second poles, can be accurately generated at least for the first component of the substance sample. The high-frequency generator may furthermore be configured to put the substance sample at least in part into a so-called “cold plasma state”. Temperatures of up to 200° C. prevail in the substance sample in a cold plasma state, whereby the substance sample remains chemically stable. In particular, no combustion, pyrolysis or the like is brought about in the substance sample in a cold plasma state. Such cold plasma states are particularly advantageously achievable using the stated excitation frequencies.

Furthermore, the high-frequency generator can be amplitude-modulated via a rising ramp signal. The rising ramp signal can be easily generated by the control unit and makes it possible to generate different field strengths in the measurement cell in targeted manner. The smaller the rise in the ramp function, the longer it takes to reach field strengths at which all the components of the substance sample are ionized. As a function of a specifiable duration of a measurement cycle for the substance sample, it is possible to determine a minimum rise in the ramp signal at which the highest achievable measuring accuracy is achieved. The inventive method is accordingly easily adaptable to the requirements of the particular application in terms of measurement speed and measurement accuracy. The rising ramp signal can furthermore be modulated with a sine signal, so enabling synchronous demodulation. Here, the sine signal has a frequency that is located in the acoustic spectrum.

In a further embodiment of the inventive method, the first pole generates a measurement signal that takes the form of an output voltage. The output voltage contains an electrical quantity that corresponds to the conductivity between the first and second poles. The output voltage is filtered via a “bias tee” and/or a low-pass filter. The output voltage is generated by a change in conductivity in the substance sample. The bias tee or the low-pass filter filter out high-frequency components, brought about by the high-frequency generator, from the output voltage. The output voltage is thus substantially reduced to a DC voltage. The filtered output voltage, i.e., a DC voltage component of the unfiltered output voltage, in turn describes the rise in conductivity between the first and second poles. Bias tees and low-pass filters are reliable, cost-effective and offer effective filtering of the output voltage arising at the first pole. An output voltage filtered in this manner can be quickly evaluated with greater accuracy.

A measurement voltage can furthermore be generated from the DC voltage component of the output voltage. The measurement voltage is generated via a transimpedance amplifier to which the DC voltage component of the output voltage is indirectly supplied as input via an interposed DC voltage source. As a result, the DC voltage component of the output voltage is converted into an accurately readable measurement voltage. The DC voltage component is thus converted into an easily readable measurement voltage substantially by a minimum of active electrical components and is thus cost-effectively implementable. Alternatively or additionally, it is also possible to provide a resistor on which the voltage arising is measurable in order to suggest the associated direct current.

In a further embodiment of the inventive method, the first pole of the detector can be connected to a circulator and a load resistor. A high-frequency voltage component reflected in the first pole can be captured via a circulator and a load resistor. Here, the high-frequency voltage can be generated by the high-frequency generator. The reflected high-frequency power can accordingly be dissipated via the circulator and the load resistor. This permits ongoing use of the high-frequency generator to generate the electromagnetic field. The circulator and load resistor can be arranged between the high-frequency generator and the bias tee and so act as an isolator. In particular, this reliably protects the detector against a returning wave of the high-frequency voltage. The high-frequency power dissipated at the circulator and load resistor is a measure of the change in impedance at the first or second pole.

The first pole may furthermore take the form of a spike at the tip of which a maximum field strength prevails. Ionization of the first or second component of the substance sample first occurs in the region of the maximum field strength. There is accordingly a region at the tip of the first pole in the form of a spike in which the first or second rise in conductivity occurs. As a consequence, the first or second rise in conductivity of the substance sample can be accurately detected in the third or sixth step. As a result, the inventive method offers greater measurement accuracy. In particular, the substance sample can be supplied in the proximal direction, i.e., from a free end of the spike. The effect of the electromagnetic field is minimized at an end remote from the first pole, i.e., the spike. The electromagnetic field consequently acts on the substance sample in a substantially stepwise manner, i.e., with a minimized start-up region. This further raises the measurement accuracy of the inventive method.

The substance sample can furthermore be continuously introduced into the measurement cell. Introduction into the measurement cell may be performed adjustably, for example, by specifying a substance sample supply pressure. The inventive method offers greater measurement speed, such that the composition of the substance sample can also be detected substantially continuously. To this end, the measurement cell may be provided with an outlet duct through which a substance sample can be discharged from the measurement cell. The outlet duct may furthermore be provided with a restrictor. A pressure prevailing in the substance sample in the measurement cell is consequently adjustable. The pressure prevailing in the substance sample influences the achievable measurement accuracy.

The objects and advantages are likewise achieved in accordance with the invention by a detector that comprises a measurement cell into which a substance sample whose composition is to be detected via the detector is introduced. A first pole, which is surrounded by a second pole, is arranged in the measurement cell. The first pole is connected to a high-frequency generator that is configured to excite an electromagnetic field. As a result of the connection between the first pole and the high-frequency generator, an electromagnetic field can thus be generated between the first and second poles. The electromagnetic field may be adjustable, in particular in terms of field strength, by a user and/or a control unit. The substance sample whose composition is to be determined is introducible into an interspace between the first and second poles. In accordance with the invention, the first pole is provided with a suitable further detector for identifying a first component of the substance sample and/or for detecting a concentration of the first component of the substance sample. The further detector is configured to detect a change in conductivity that prevails between the first and second poles. At least the first component can be identified or its concentration established by detecting the change in conductivity between the first and second poles. Ionization, that results in a change in the conductivity of the substance sample can be brought about in the first component by the electromagnetic field. The first component of the substance sample has an invariable ionization energy that is characteristic of the component. The field strength that prevails when ionization of the first component, and thus the change in conductivity of the substance sample, occurs is uniquely related to the substance forming the first component. A magnitude by which the conductivity changes is a measure of the concentration of the first component. The further detector that is connected to the first pole substantially measures electrical quantities and thus offers an elevated level of measurement accuracy. The first component of the substance sample is accordingly reliably identifiable and/or its concentration determinable. The detector may furthermore be configured to implement at least one of the above-disclosed methods.

In one embodiment of the inventive detector, the second pole can at least in part surround the first pole, when viewed in cross-section. The second pole may accordingly have a closed cross-section which may be, for example, circular, oval, elliptical or polygonal. As a result of such a closed cross-section, the electromagnetic field between the first and second poles is substantially free of edge effects and consequently has accurately predictable characteristics. Alternatively, the second pole may have a cross-section that is substantially U-shaped, C-shaped or omega-shaped. Edge effects can be minimized with corresponding cross-sections, so simultaneously ensuring straightforward installation.

In a further embodiment of the inventive detector, a plurality of measurement cells each having a first and second pole, between which an electromagnetic field is generated via a high-frequency generator, may also be provided. The respective electromagnetic fields have a constant field strength and are coupled together via the control unit to identify the composition of the substance sample. Here, the respective electromagnetic fields have mutually differing constant field strengths. As a result, the high-frequency generators are more simply actuatable and can be each designed for an optimized continuous operating point. Overall, this implements the principle of parallelized measurement. The number of measurement cells may advantageously correspond to the number of components in the substance sample.

In a further embodiment of the inventive detector, the first pole may be connected to a bias tee, a low-pass filter and/or a transimpedance amplifier. A DC voltage that is overlaid with a high-frequency voltage can be brought about in the first pole by the first and/or second rise in conductivity between the first and second poles. In order to detect the first or second rise in conductivity, a DC voltage component is separated from the high-frequency voltage by signal processing with the bias tee and/or the low-pass filter. Here, the low-pass filter may also take the form of a plurality of individual low-pass filters that are interconnected. A DC voltage signal isolated in this way via the bias tee and/or low-pass filter, which corresponds to the DC voltage component, can be indirectly or directly forwarded as an input signal to the transimpedance amplifier. To this end, the DC voltage signal, i.e., the DC voltage component, may inter alia be used to bring about a direct current. Here, the direct current here serves as measurement current. The transimpedance amplifier should inter alia be taken to mean an electronic component or assembly that is suitable for generating under current control a proportional output voltage that permits simple measurement. Here, the output voltage is an output voltage of the detector that is more easily measurable than the isolated DC voltage signal. The output voltage is thus a detector measurement signal. The DC voltage signal has only a small magnitude, for example, of up to 10 volts. The bias tee, the low-pass filter and the transimpedance amplifier are relatively simple components that reliably and cost-effectively enable measurement of the first or second rise in conductivity between the first and second poles.

The objects and advantages are likewise achieved in accordance with the invention by a computer program product that is configured to receive and process a measurement signal from a detector. The detector is configured to identify a first component of a substance sample and/or determine a concentration of the first component of the substance sample. The computer program product may be stored in remanent form in a data storage medium, for example, a memory unit of a control unit. The computer program product may furthermore be executable via a computing unit, such as a processor of the control unit. In accordance with the invention, the computer program product is configured to implement at least one of embodiment of the disclosed method.

The objects and advantages are further achieved in accordance with the invention by a control unit having a memory unit for remanent storage of computer program products and a computing unit for executing the computer program products. The control unit is configured to operate a detector, i.e., is couplable therewith, and is suitable for receiving measurement signals from the detector. The control unit is also configured to send control commands to components of the detector. In particular, the control unit is couplable with a high-frequency generator and/or a transimpedance amplifier of the detector. The high-frequency generator is actuatable via the control unit with control commands and the transimpedance amplifier can receive measurement signals. In order to ensure intended operation of the detector, the control unit is equipped with a suitable computer program product. In accordance with the invention, the computer program product is configured in accordance with the disclosed embodiments set out above.

The objects and advantages are furthermore achieved in accordance with the invention by a detector system that is configured to determine a composition of a substance sample. The detector system comprises a further detector that is coupled with a control unit. In accordance with the invention, the detector is configured in accordance with the disclosed embodiments outlined above. Alternatively or additionally, the control unit may be configured in accordance with one of the above-described embodiments.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is explained in greater detail below on the basis of individual embodiments in figures. The figures should be read to be mutually complementary in the respect that identical reference signs in different figures have the same technical meaning. The features of the individual embodiments may also be combined with one another. The embodiments shown in the figures may also be combined with the features outlined above, in which:

FIG. 1 shows a schematic illustration of the structure of a first embodiment of the inventive detector;

FIG. 2 shows a first embodiment of the inventive method in a diagram;

FIG. 3 shows a schematic illustration of the structure of a first embodiment of an inventive detector system;

FIG. 4 is an illustration of the flowchart of the method in accordance with the invention.

### DETAILED DESCRIPTION OF THE EXEMPLARY EMBODIMENTS

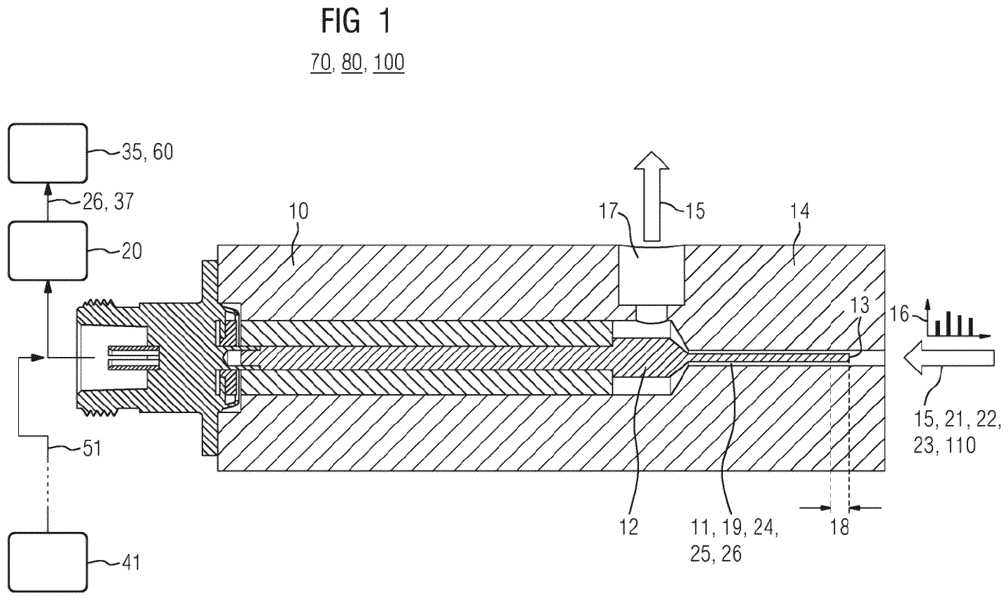

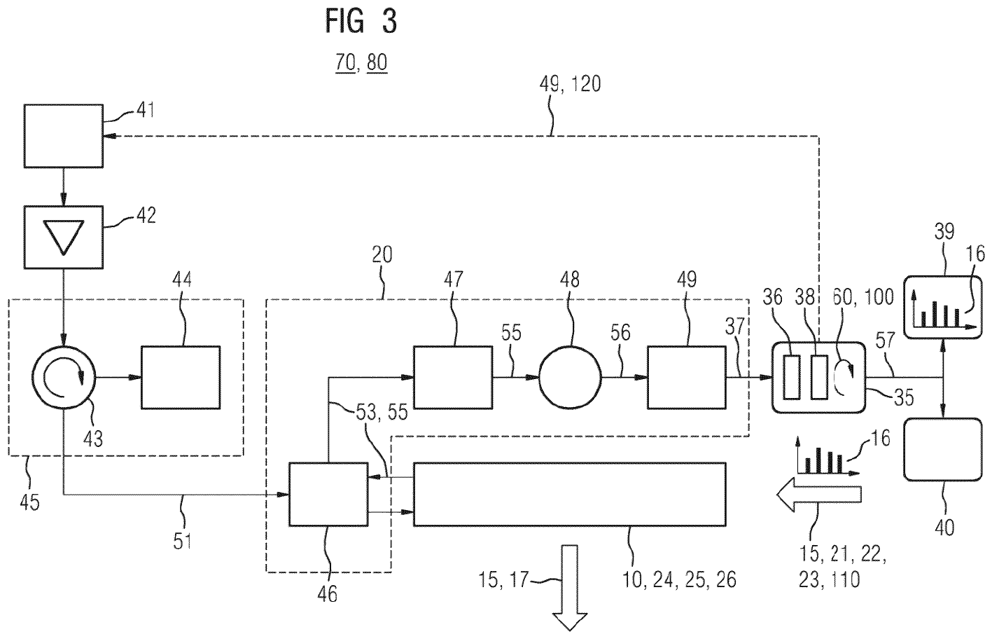

FIG. 1 diagrammatically shows a longitudinal section of a first embodiment of the inventive detector 10. The detector 10 comprises a first pole 12, which substantially takes the form of a spike, which is accommodated in a housing that acts as the second pole 14. At least in the region of a tip 13 of the spike, i.e., of the first pole 12, an interspace 19 serving as a measurement cell 11 is formed between the first pole 12 and the second pole 14. A substance sample 15 that has a composition 16 that is to be determined using the detector 10 is introducible into the measurement cell 11. The substance sample 15 has at least one first, one second and one third component 21, 22, 23 (see FIG. 3). In an appropriate method 100 for operating the detector 10, the substance sample 15 can furthermore be supplied continuously or intermittently in a first step 110. The first pole is connected to a high-frequency generator 41, via which a controllable high-frequency signal 51, which is supplied to the first pole 12, is at least indirectly brought about. The high-frequency signal 51 brings about an electromagnetic field 24, which has a correspondingly variable field strength 25, between the first pole 12 and the second pole 14. A maximum field strength 25 of the electromagnetic field 24 prevails in an end region 18 at the tip 13 of the first pole 12. As a result of the supplied substance sample 15, a conductivity 26 prevails between the first pole 12 and the second pole 14. As a result of the electromagnetic field 24, the substance sample 15 is ionizable component-by-component by appropriate actuation of the high-frequency generator 41 in the end region 13 of the first pole 12, i.e., in the region of its tip 13. The greater the field strength 25 between the first pole 12 and the second pole 14, the more components of the substance sample 15 are ionized, such that the conductivity 26 between the first pole 12 and the second pole 14 is raised or becomes conductive.

Such rises in the conductivity 26 of the substance sample 15, which is located between the first pole 12 and the second pole 14, can be detected via further detector 20. The detector 20 can generate corresponding measurement signals 37 that can be evaluated via a control unit 35. Operation of the high-frequency generator 41, detecting of the conductivity 26 between the first and second poles 12, 14 and determination of the composition 16 of the substance sample 15 can be performed in the inventive method 100. The detector 10 also has an outlet duct 17 through which the substance sample 15 can be discharged once the method 100 has been performed. The pressure and flow rate prevailing in the measurement cell 11 are, for example, adjustable by a restrictor in the outlet duct 17 and supply of the supplied substance sample 15.

The control unit 35 is furthermore equipped with a computer program product 60 by which the inventive method 100 can be implemented in conjunction with the inventive detector 10. The detector 10, further detector 20, control unit 35 and high-frequency generator 41 are part of a detection system 80 that is configured to implement the inventive method 100. The structure of at least the detector 10 is stored in a digital twin 70 that is not shown in greater detail. Component-by-component ionization behavior of the substance sample 15, i.e., a change in the conductivity 26 of the substance sample 15 as a function of the prevailing variable field strength 25, is an operating behavior of the detector 10 that can be simulated via the digital twin 70.

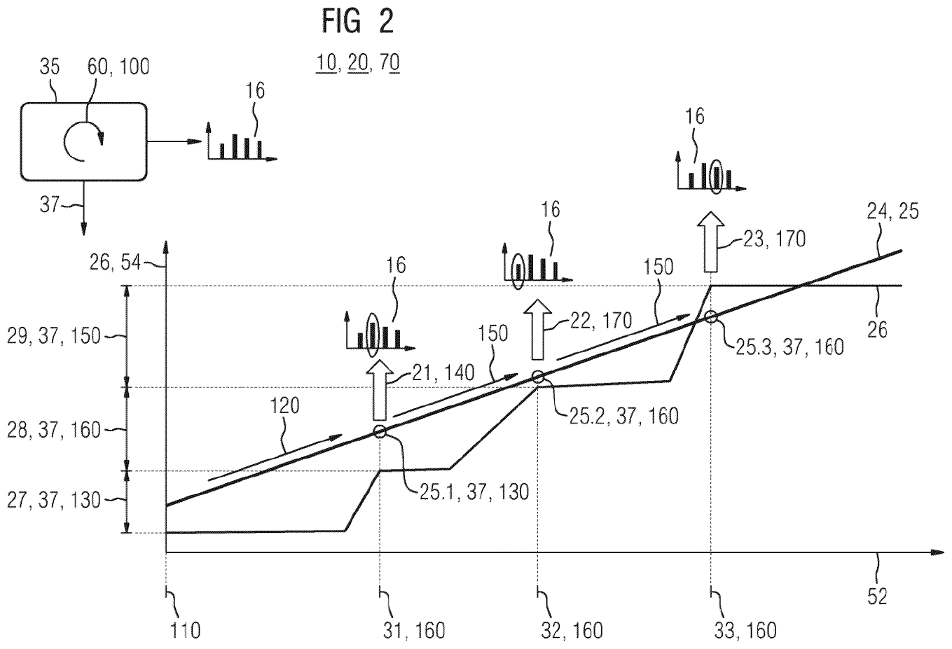

FIG. 2 shows a diagram 50 of a first embodiment of the inventive method 100. The diagram 50 has a horizontal time axis 52 and a vertical quantity axis 54 from which values for field strength 25 and for conductivity 26 between a first and second pole 12, 14, as shown, for example, in FIG. 1, can be read. The method 100 starts from a state in which an inventive detector 10 is provided in a functional state and a substance sample 15 is supplied that includes a first component 21, a second component 22 and a third component 23. The method 100 serves to determine a composition 16 of the substance sample 15. This involves identifying at least the first component 21 and detecting a concentration of the first component 21.

In a second step 120 of the method 100, an electromagnetic field 24, which has a rising, i.e., variable, field strength 25, is brought about between the first and second poles 12, 14 of the detector 10. As the field strength 25 rises, the conductivity 26 between the first and second poles 12, 14 of the detector 10 remains substantially identical. As soon as the electromagnetic field 24 reaches a first ionization energy 31 in the substance sample 15, the first component 21 thereof is ionized. Ionization of the first component 21 raises the conductivity 26. In a third step 130, a first rise 27 in conductivity 26 occurs that can be detected in the form of measurement signals 37. A time gradient, i.e., a steepness of the first rise 27 in conductivity 26 in the diagram 50, can also be detected in the third step 130 in the form of measurement signals 37. The measurement signals 37 can be evaluated by a control unit 35, as also shown in FIG. 1. The field strength 25 prevailing during the first rise 27 in conductivity 26, i.e., a first field strength 25.1, is further detected in the third step 130. This is likewise sent to the control unit 35 as a measurement signal 37. Here, the first field strength 25.1 is detected indirectly via appropriately configured further detector 20 (not shown in greater detail) that is connected to the detector 10.

A fourth step 140 follows in which the first component 21 is identified and its concentration determined. The fourth step 140 is implemented in the control unit 35 via a computer program product 60 that is suitable for receiving and processing the measurement signals 37. The substance from which the first component 21 is made is identifiable from the field strength 25 prevailing during the first rise 27 and/or the gradient of the first rise 27. Substances are uniquely identifiable from their characteristic ionization behavior, this forming the basis for the fourth step 140. The concentration of the first component 21 is furthermore reflected by a magnitude of the first rise 27 in conductivity 26. Ionization of the first component 21 renders it electrically conductive. The higher the concentration of the first component 21 in the substance sample 15, the larger the conductive portion of the substance sample 15 present in the third step 130.

A fifth step 150 follows in which the field strength 25 is raised further in substantially the same way as in the second step 120. A sixth step 160 follows in which the prevailing field strength 25 in the substance sample 15 reaches a second ionization energy 32. Once the second ionization energy 32 is reached, a second component 22 of the substance sample 15 is ionized and thus the conductivity 26 of the substance sample 15 raised further. In the sixth step 160, the magnitude of the second rise 28 in conductivity 26 is detected, as is a field strength 25, at which the second rise 28 occurs, i.e., a second field strength 25.2. In the same way as the first field strength 25.1, the second field strength 25.2 can also be indirectly detected via further detector 20 not shown in any greater detail. A gradient of the second rise 28, in particular a time gradient, can likewise be detected. In a seventh step 170 of the method 100, the second component 22 is determined based on the field strength 25 at which the second rise 28 in conductivity 26 occurs, i.e., the second field strength 25.2. Suitable measurement signals 37 are transmitted to the control unit 35 for this purpose. Substantially in a similar manner to the first component 21 in the fourth step 140, the ionization behavior of the second component 22 is characterized by the second field strength 25.2 prevailing during the second rise 28, and/or the gradient thereof. The second component 22 is accordingly identified in the seventh step 170. Likewise in a similar manner to the first component 21 in the fourth step 140, the concentration of the second component 22 is determined in the seventh step 170 based on the magnitude of the second rise 28.

Similarly, the fifth, sixth and seventh steps 150, 160, 170 are performed repeatedly to identify a third component 23 in substance sample 15 and determine its concentration. The determined composition 16 can be output to a user via the control unit 35. The control unit 35 is furthermore equipped with a suitable computer program product 60 that is configured to implement the inventive method 100.

FIG. 3 is a diagrammatic representation of a structure of a detector system 80 with an inventive detector 10. The detector 10 may be configured in accordance with the embodiment of FIG. 1. The detector system 80 has a high-frequency generator 41 that is configured to generate a high-frequency signal 51 with an excitation frequency of at least 1 MHz, preferably of at least 1 GHz and particularly preferably of 2.0 to 4.0 GHz. The high-frequency generator 41 is coupled with an amplifier 42 that amplifies the high-frequency signal 51 to generate an electromagnetic field 24 in the detector 10. The amplifier 24 is further coupled with a circulator 43 and with a load resistor 44 that are configured to dissipate a high-frequency signal reflected from the detector 10, i.e., substantially to convert it into heat. The circulator 43 and load resistor 44 thus function as an isolator 45 that protects the high-frequency generator 41 and the amplifier 42. The isolator 45 is in turn coupled with a “bias tee” 46 that is configured to direct the high-frequency signal 51 generated by the high-frequency generator 41 and the amplifier 42 into the detector 10 to bring about the electromagnetic field 24 therein. The radio-frequency amplifier 41 is actuatable via control commands 49 from a control unit 35, such that the high-frequency signal 51 is variable. The field strength 25 of the electromagnetic field 24 is consequently adjustable in the second step 120 of a corresponding method 100. The electromagnetic field 24 in the detector 10 is accordingly also variable in terms of field strength 25. The variable field strength 25 ionizes a substance sample 15 supplied to a measurement cell 11 of the detector 10 component-by-component, so resulting in changes in conductivity 26 in the substance sample 15. The changes in conductivity 26 in the substance sample 15 generate an output voltage 53 that comprises the high-frequency signal 51 reflected in the detector 10. In addition to a high-frequency component, the output voltage 53 comprises a DC voltage component 55 that is characteristic of a conductivity 26 of the substance sample 15 prevailing in the detector 10. The bias tee 46 extracts the output voltage 53 for further processing. In order to determine the DC voltage component 55 in the output voltage 53, the output voltage 53 is filtered via at least one low-pass filter 47. The low-pass filter 47 according to FIG. 3 may comprise a plurality of low-pass filter components. The DC voltage component 55 is supplied to a DC voltage source 48, which takes the form of a battery, via the low-pass filter 47. The DC voltage source 48 generates, from the DC voltage component 55, a DC signal that serves as measurement current 56 and is forwarded to a transimpedance amplifier 49. A measurement signal 37 of the detector 10 is generated via the transimpedance amplifier 49 and the DC signal, i.e., the measurement current 56. The bias tee 46, the low-pass filter 47, the DC voltage source 48 and the transimpedance amplifier 49 are part of the further detector 20 that are coupled with the detector 10 and serve to generate measurement signals 37 for detecting the changes in conductivity 26 in the substance sample 15. The measurement signals 37 are forwarded to the control unit 35, which has a memory unit 36 and a computing unit 38 via which a computer program product 60 is executable. The computer program product 60 is configured to perform at least one embodiment of the inventive method 100 and is accordingly suitable for receiving and processing measurement signals 37. The composition 16 of the substance sample 15 is determinable via the method 100, and thus also via the computer program product 60. This involves identifying first, second and third components 21, 22, 23 of the substance sample 15. The determined composition 16 is output via a communication data link 57 to a display unit 39. The determined composition 16 is likewise output to a higher-level control unit 40 that may take the form of a master computer, programmable controller, and/or computer cloud. The communication data link 57 may take the form of a network link, internet link and/or mobile radio link. After passing through the measurement cell 11, the substance sample 15 is discharged again from the measurement cell 11 and thus from the detector 10 via an outlet duct 17 not shown in any greater detail. The detector system 80 shown in FIG. 3 is modeled in a digital twin 70 that can simulate the operational behavior of the system. In addition to the ionization behavior of the substance sample 15, the operational behavior also includes the electrical behavior of the further detector 20, i.e., its processing of the output voltage 53 from the detector 10. The digital twin 70 is configured to identify a defective or deteriorating component of the detector 10, the further detector 20, the high-frequency generator 41, the amplifier 42 and/or the isolator 45. A detected operational behavior of the detector system 80 may to this end be compared with an operational behavior simulated via the digital twin 70 and checked for plausibility.

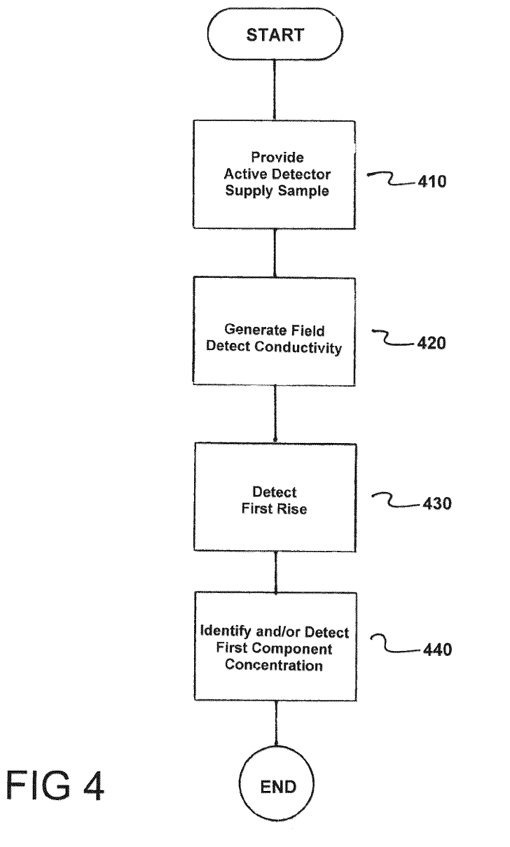

FIG. 4 is a flowchart of the method 100 for detecting a composition 16 of a substance sample 15 that includes at least one first and second component 21, 22 via a detector 10. The method comprises a) providing the detector 10 in an active operating state and supplying the substance sample 15 to a measurement cell 11, as indicated in step 410.

Next, b) an electromagnetic field 24 with an adjustable field strength 25 is generated in the measurement cell 11 and a conductivity 26 between a first and a second pole 12, 14 of the measurement cell 11 is detected, as indicated in step 420.

Next, c) detecting a first rise in conductivity 26 between the first and second poles 12, 14 and a field strength 25 prevailing during the first rise 27 are detected, as indicated in step 430.

Next, d) the first component 21 is identified and/or a concentration of the first component 21 of the substance sample 15 is detected based on the first rise in conductivity 26 detected in step 430 and the field strength 25 prevailing at that time, as indicated in step 440.

In accordance with the method of the invention, the first pole 12 is surrounded at least in part by the second pole 14, and the electromagnetic field 24 is generated via a high-frequency generator 41, which is connected to the first pole 12.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-18. (canceled)

19. A method for detecting a composition of a substance sample which includes at least one first and second component via a detector, the method comprising:
a) providing the detector in an active operating state and supplying the substance sample to a measurement cell;
b) generating an electromagnetic field with an adjustable field strength in the measurement cell and detecting a conductivity between a first and a second pole of the measurement cell;
c) detecting a first rise in conductivity between the first and second poles and a field strength prevailing during the first rise; and
d) identifying the first component and/or detecting a concentration of the first component of the substance sample based on the first rise in conductivity detected in step c) and the field strength prevailing at that time;
wherein the first pole is surrounded at least in part by the second pole; and
wherein the electromagnetic field is generated via a high-frequency generator, which is connected to the first pole.

20. The method as claimed in claim 19, wherein the first pole is surrounded by the second pole.

21. The method as claimed in claim 19, wherein the second pole has one of a closed, a U-shaped, a C-shaped and omega-shaped cross-section.

22. The method as claimed in claim 19, wherein a concentration of the first component is determined based on a magnitude of the first rise in conductivity.

23. The method as claimed in claim 20, wherein a concentration of the first component is determined based on a magnitude of the first rise in conductivity.

24. The method as claimed in claim 21, wherein a concentration of the first component is determined based on a magnitude of the first rise in conductivity.

25. The method as claimed in claim 19, wherein the first component is identified based on at least one of (i) at least the field strength prevailing during the first rise in conductivity and detected in step c), and (ii) based on a conductivity gradient prevailing in step c).

26. The method as claimed in one of claims 19, wherein the method further comprises:
e) further generating the electromagnetic field with an adjustable field strength in the measurement cell and further detecting the conductivity between the first and second poles of the measurement cell;
f) detecting a second rise in conductivity between the first and second poles and a field strength prevailing during the second rise; and
g) identifying the second component and/or detecting a concentration of the second component of the substance sample based on the second rise in conductivity detected in step f) and the field strength prevailing at that time.

27. The method as claimed in claim 19, wherein the high-frequency generator is amplitude-modulated via a rising ramp signal.

28. The method as claimed in claim 19, wherein a detected output voltage is filtered via at least one of (i) a bias tee and (ii) a low-pass filter; and wherein the output voltage is generated by a change in conductivity in the substance sample.

29. The method as claimed in claim 19, wherein a measurement current generated by a DC voltage component of the output voltage is amplified via a transimpedance amplifier.

30. The method as claimed in claim 19, wherein the first pole of the detector is connected to a circulator and a load resistor.

31. The method as claimed in claim 19, wherein the first pole is formed as a spike at the tip of which a maximum field strength prevails.

32. The method as claimed in claim 19, wherein the substance sample is passed continuously into the measurement cell.

33. A detector comprising:
a high-frequency generator; and
a further detector for detecting a change in conductivity of a substance sample,
a measurement cell in which a first pole and a second pole are arranged, the first pole being connected to the high-frequency generator for generating an electromagnetic field, and the substance sample being introducible between the first and second poles, and the first pole being connected to the further detector for at least one of identifying and detecting a concentration of a first component of the substance sample;
wherein the first pole is surrounded by the second pole.

34. The detector as claimed in claim 32, wherein the second pole has one of a closed, a U-shaped, a C-shaped and an omega-shaped cross-section.

35. The detector as claimed in claim 33, wherein the second pole has one of a closed, a U-shaped, a C-shaped and an omega-shaped cross-section.

36. The detector as claimed in claim 32, wherein the first pole is connected to at least one of a bias tee, a low-pass filter and a transimpedance amplifier.

37. The detector as claimed in claim 33, wherein the first pole is connected to at least one of a bias tee, a low-pass filter and a transimpedance amplifier.

38. The detector as claimed in claim 34, wherein the first pole is connected to at least one of a bias tee, a low-pass filter and a transimpedance amplifier.
